(19) United States
(12) Patent Application Publication
(10) Pub. No.: US 2011/0300516 A1
(43) Pub. Date: Dec. 8, 2011

(54) Tactile Tile Vocalization

(75) Inventors: Daniel Wigdor, Seattle, WA (US); Meredith June Morris, Bellevue, WA (US); Jarrod Lombardo, Bellevue, WA (US); Annuska Perkins, Redmond, WA (US); Sean Hayes, Lampeter (GB); Curtis Douglas Aumiller, Redmond, WA (US)

(73) Assignee: MICROSOFT CORPORATION, Redmond, WA (US)

(21) Appl. No.: 12/791,962

(22) Filed: Jun. 2, 2010

(51) Int. Cl. G06K 9/00

(52) U.S. Cl. 434/116

(57) ABSTRACT

Braille symbols are automatically read aloud, to aid in learning or using Braille. More generally, a tile which bears a tactile symbol and a corresponding visual symbol is placed in a sensing area, automatically distinguished from other tiles, and vocalized. The tile is sensed and distinguished from other tiles based on various signal mechanisms, or by computer vision analysis of the tile's visual symbol. Metadata is associated with the tile. Additional placed tiles are similarly sensed, identified, and vocalized. When multiple tiles are placed in the sensing area, they are vocalized individually, and an audible phrase spelled by their arrangement of tactile symbols is also produced. A lattice is provided with locations for receiving tiles. Metadata are associated with lattice locations. Tile placement is used to control an application program which responds to tile identifications.

### BACKGROUND

Braille is the mechanism blind people use most frequently to read and write. The original Braille encoding was invented in 1821 by Louis Braille. Braille encoding uses raised dots in a rectangular array to represent written characters. The characters may be from a natural language such as French or English, but Braille encoding has also been expanded to write “characters” in mathematics, music, and other notations. Some Braille encodings use six-dot arrays, and some use eight-dot arrays. Because the number of dot patterns easily distinguishable by touch is relatively limited, many Braille characters have meanings which vary based on context. The mapping between Braille characters and characters in a given natural language is generally not one-to-one. Some kinds of Braille transcription also use contractions to help increase reading speed.

In addition to Braille, other forms of writing for blind people have been devised. For example, Moon writing uses embossed symbols largely derived from a simplified Roman alphabet. Some people find Moon writing easier to understand than Braille, although Moon writing is mainly used by people who lost their sight sometime after learning the visual shapes of letters. Instead of the dots of Braille, Moon writing uses raised curves, angles, and lines; an alphabet in Moon includes nine glyphs in various orientations. In some forms of Moon writing, the characters can represent individual sounds, parts of words, whole words or numbers.

### SUMMARY

Learning Braille or another tactile notation often requires dedicated effort over an extended period. Individualized instruction by a sighted teacher generally provides the most effective results, but financial, geographic, and other constraints can make it difficult or impractical for students to receive sufficient instruction. Braille literacy is low within the blind community.

Some embodiments described herein provide a computerized system capable of reading Braille symbols aloud, to aid people in learning and/or using Braille. Some embodiments audibly assist a user of tactile symbols by (a) electronically determining that a tile which bears a tactile symbol and a corresponding visual symbol has been placed in a sensing area, (b) automatically distinguishing the placed tile from other tiles, and (c) electronically producing an audible phrase denoted by the tactile symbol of the placed tile. The tile's tactile symbol may be in Braille, Moon, or another tactile notation. The tile may be sensed and/or distinguished from other tiles based on a magnetic signal, a signal generated by the tile physically intercepting a light beam, an induced capacitance signal, or a computer vision analysis of the tile's visual symbol, for example. Metadata may also be associated with the tile.

Additional placed tiles can be similarly sensed, identified, and vocalized. When multiple tiles are placed in the sensing area, they can be vocalized individually, or an audible phrase spelled by their arrangement of tactile symbols can be produced. Some embodiments electronically produce an audible phrase that is spelled by a sequence of placed titles when those tiles are physically separated from one another by less than a predetermined separation distance. Some embodiments provide a lattice above or integral with the sensing area, having locations for receiving tiles. Metadata may be associated with lattice locations. For example, a lattice cell's name may be electronically spoken when a tile is placed in the lattice cell. In some embodiments, tile placement can be used to control an application program which is configured to respond to tile identifications.

The examples given are merely illustrative. This Summary is not intended to identify key features or essential features of the claimed subject matter, nor is it intended to be used to limit the scope of the claimed subject matter. Rather, this Summary is provided to introduce—in a simplified form—some concepts that are further described below in the Detailed Description. The innovation is defined with claims, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating a computer system having at least one processor, at least one memory, at least one application program, and other items in an operating environment which may be present on multiple network nodes, and also illustrating configured storage medium embodiments;

FIG. 2 is a block flow diagram illustrating a multisensory system for tactile symbol vocalization, which may include and/or be in operable communication with one or more computer systems;

FIG. 3 is a flow chart illustrating steps of some process and configured storage medium embodiments;

FIGS. 4 through 8 illustrate a sequence of placements of bisensory tiles in a sensing area of a multisensory system for tactile symbol vocalization;

FIG. 9 corresponds generally with FIG. 8 but illustrates an alternative multisensory system configuration in which visual symbols corresponding to placed tiles are also generated and displayed;

FIG. 10 illustrates a lattice positioned over a sensing area of a multisensory system; and

FIG. 11 illustrates a particular bisensory tile of a multisensory system for tactile symbol vocalization.

### DETAILED DESCRIPTION

### Overview

When a non-sighted person attempts to learn Braille, learning is sometimes hampered by a lack of feedback. Specifically, when a student of Braille is stymied by a Braille symbol, they may seek assistance from a sighted person to provide or verify a reading of the symbol. Some embodiments described herein help reduce or even eliminate a student's reliance on sighted people for such feedback, by providing a computerized system capable of vocalizing Braille, that is, “reading” Braille symbols aloud.

In some embodiments, Braille is printed on small tangible objects referred to as “tiles”. A computer vision system and/or another mechanism is used to identify the tiles. When a tile is placed in a designated area, the system speaks aloud the letter printed on it. When the tiles are placed adjacent to one another, the system speaks the word created by those letters.

Reference will now be made to exemplary embodiments such as those illustrated in the drawings, and specific language will be used herein to describe the same. But alterations and further modifications of the features illustrated herein, and additional applications of the principles illustrated herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage, in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise their right to their own lexicography. Terms may be defined, either explicitly or implicitly, here in the Detailed Description and/or elsewhere in the application file.

As used herein, a “computer system” may include, for example, one or more servers, motherboards, processing nodes, personal computers (portable or not), personal digital assistants, cell or mobile phones, and/or device(s) providing one or more processors controlled at least in part by instructions. The instructions may be in the form of software in memory and/or specialized circuitry. In particular, although it may occur that many embodiments run on workstation or laptop computers, other embodiments may run on other computing devices, and any one or more such devices may be part of a given embodiment.

A “multithreaded” computer system is a computer system which supports multiple execution threads. The term “thread” should be understood to include any code capable of or subject to synchronization, and may also be known by another name, such as “task,” “process,” or “coroutine,” for example. The threads may run in parallel, in sequence, or in a combination of parallel execution (e.g., multiprocessing) and sequential execution (e.g., time-sliced). Multithreaded environments have been designed in various configurations. Execution threads may run in parallel, or threads may be organized for parallel execution but actually take turns executing in sequence. Multithreading may be implemented, for example, by running different threads on different cores in a multiprocessing environment, by time-slicing different threads on a single processor core, or by some combination of time-sliced and multi-processor threading. Thread context switches may be initiated, for example, by a kernel's thread scheduler, by user-space signals, or by a combination of user-space and kernel operations. Threads may take turns operating on shared data, or each thread may operate on its own data, for example.

A “logical processor” or “processor” is a single independent hardware thread-processing unit. For example a hyperthreaded quad core chip running two threads per core has eight logical processors. Processors may be general purpose, or they may be tailored for specific uses such as graphics processing, signal processing, floating-point arithmetic processing, encryption, I/O processing, and so on.

A “multiprocessor” computer system is a computer system which has multiple logical processors. Multiprocessor environments occur in various configurations. In a given configuration, all of the processors may be functionally equal, whereas in another configuration some processors may differ from other processors by virtue of having different hardware capabilities, different software assignments, or both. Depending on the configuration, processors may be tightly coupled to each other on a single bus, or they may be loosely coupled. In some configurations the processors share a central memory, in some they each have their own local memory, and in some configurations both shared and local memories are present.

“Kernels” include operating systems, hypervisors, virtual machines, and similar hardware interface software.

“Application programs” include software which interacts directly with a human user, through an interface which provides visual and/or audible output and accepts input controlled by physical movement of one or more input devices.

“Code” means processor instructions, data (which includes constants, variables, and data structures), or both instructions and data.

“Automatically” means by use of automation (e.g., general purpose computing hardware configured by software for specific operations discussed herein), as opposed to without automation. In particular, steps performed “automatically” are not performed by hand on paper or in a person's mind; they are performed with a machine.

Throughout this document, use of the optional plural “(s)” means that one or more of the indicated feature is present. For example, “tile(s)” means “one or more tiles” or equivalently “at least one tile”.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a step involving action by a party of interest such as “transmitting to”, “sending toward”, or “communicating to” a destination may involve intervening action such as forwarding, copying, uploading, downloading, encoding, decoding, compressing, decompressing, encrypting, decrypting and so on by some other party, yet still be understood as being performed directly by the party of interest.

Whenever reference is made to data or instructions, it is understood that these items configure a computer-readable memory thereby transforming it to a particular article, as opposed to simply existing on paper, in a person's mind, or as a transitory signal on a wire, for example.

Operating Environments

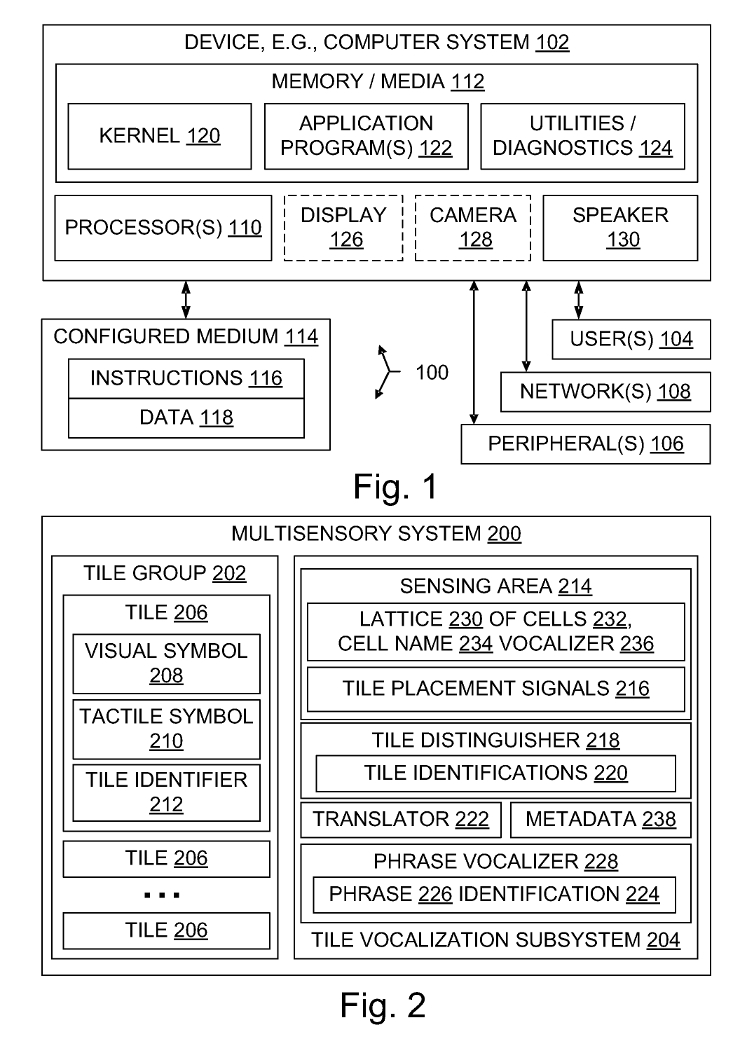

With reference to FIG. 1, an operating environment 100 for an embodiment may include a computer system 102. The computer system 102 may be a multiprocessor computer system, or not. An operating environment may include one or more machines in a given computer system, which may be clustered, client-server networked, and/or peer-to-peer networked.

Human users 104 may interact with the computer system 102 by using displays, keyboards, and other peripherals 106. System administrators, developers, engineers, and end-users are each a particular type of user 104. Automated agents acting on behalf of one or more people may also be users 104. Storage devices and/or networking devices may be considered peripheral equipment in some embodiments. Other computer systems not shown in FIG. 1 may interact with the computer system 102 or with another system embodiment using one or more connections to a network 108 via network interface equipment, for example.

The computer system 102 includes at least one logical processor 110. The computer system 102, like other suitable systems, also includes one or more computer-readable non-transitory storage media 112. Media 112 may be of different physical types. The media 112 may be volatile memory, non-volatile memory, fixed in place media, removable media, magnetic media, optical media, and/or of other types of non-transitory media (as opposed to transitory media such as a wire that merely propagates a signal). In particular, a configured medium 114 such as a CD, DVD, memory stick, or other removable non-volatile memory medium may become functionally part of the computer system when inserted or otherwise installed, making its content accessible for use by processor 110. The removable configured medium 114 is an example of a computer-readable storage medium 112. Some other examples of computer-readable storage media 112 include built-in RAM, ROM, hard disks, and other storage devices which are not readily removable by users 104.

The medium 114 is configured with instructions 116 that are executable by a processor 110; “executable” is used in a broad sense herein to include machine code, interpretable code, and code that runs on a virtual machine, for example. The medium 114 is also configured with data 118 which is created, modified, referenced, and/or otherwise used by execution of the instructions 116. The instructions 116 and the data 118 configure the medium 114 in which they reside; when that memory is a functional part of a given computer system, the instructions 116 and data 118 also configure that computer system. In some embodiments, a portion of the data 118 is representative of real-world items such as product characteristics, inventories, physical measurements, settings, images, readings, targets, volumes, and so forth. Such data is also transformed by as discussed herein, e.g., by vocalization, transcription, translation, deployment, execution, modification, display, creation, loading, and/or other operations.

A kernel 120, application program(s) 122, utility/diagnostics 124 for calibrating or testing computer vision analysis equipment, other software, metadata, signals, identifications, and other items shown in the Figures may reside partially or entirely within one or more media 112, thereby configuring those media. In addition to media 112 and processor(s) 110, an operating environment may also include other hardware, such as display 126 equipment (e.g., LCDs, other electronic visual screens, light projectors, projection surfaces, actuated pin electronic Braille displays), camera(s) 128, speaker(s) 130, buses, power supplies, and accelerators, for instance.

Items are shown in outline form in FIG. 1 to emphasize that they are not necessarily part of the illustrated operating environment, but may interoperate with items in the operating environment as discussed herein. It does not follow that items not in outline form are necessarily required, in any Figure or any embodiment.

Systems

FIG. 2 illustrates an architecture which is suitable for use with some embodiments. A multisensory system 200 may be implemented in part using a general purpose computer system 102 or other device programmed in accordance with the teachings herein. Alternatively, the multisensory system 200 may be implemented partially or entirely using PAL, ASIC, FPGA, or other special-purpose digital hardware components and circuits to obtain the functionality taught herein.

In some embodiments, the multisensory system 200 includes both a tile group 202 and a tile vocalization subsystem 204 that is configured to identify and vocalize tiles 206 of the tile group. In some cases, the tile group 202 and the tile vocalization subsystem 204 will both be provided by a single vendor. In other embodiments, the tile group 202 and the tile vocalization subsystem 204 could be provided by different vendors. Accordingly, although a tile group 202 and a tile vocalization subsystem 204 are both shown in FIG. 2 as parts of a multisensory system 200, some embodiments of a multisensory system may include only a tile group 202 and some may include only a tile vocalization subsystem 204. A given tile group 202 embodiment may interoperate with any of several different tile vocalization subsystems. Likewise, a given tile vocalization subsystem 204 embodiment may interoperate with any of several different tile groups. More generally, the Figures are illustrative only, in that a particular embodiment may omit items shown in a Figure.

In the illustrated architecture, each tile 206 bears a single visual symbol 208 and a single tactile symbol 210. In alternative embodiments, each tile 206 bears multiple visual symbols 208 and/or multiple tactile symbols 210. Visual symbols 208 are visually perceptible and generally are readily recognized by sighted persons who are fluent in the written language from which the visual symbol is taken. For example, alphanumeric characters may take the form of ink printed on a tile 206 surface. Tactile symbols 210 are three-dimensional and perceptible by touch, and generally are readily recognized by persons who are fluent in the notation from which the tactile symbol is taken. For example, tactile symbols in the form of Braille or Moon characters may be raised dots or raised glyphs, respectively, protruding from a tile 206 surface. In a variation, depressed dots or depressed glyphs may be used as tactile symbols. Various tactile communication systems may be used in tactile symbols 210, such as Braille, Moon, embossed letterform encodings, and pictorial shapes, for example.

In the illustrated architecture, each tile 206 has a tile identifier 212. Tiles in a given group may be copies, that is, multiple tiles may have the same identifier. In some embodiments, one or more visual symbols 208 borne by a tile serve as the tile's identifier 212. For instance, some multisensory systems 200 include a camera 128 and other computer vision analysis hardware and software which is configured to identify tiles by capturing and analyzing images of their visual symbols 208. In other embodiments, a different mechanism serves as the tile's identifier 212, such as a Radio Frequency ID (RFID) or other electromagnetic signaling mechanism, or a bar code, QR Code®, or other visual code, for example (QR CODE is a mark of Denso Wave Inc.). Although they may be analyzed using computer vision equipment, bar codes and other visual codes are not visual symbols 208 herein because their message content is not readily recognized by sighted persons; only their presence is readily recognized.

Tiles 206 may be formed using a variety of materials, such as plastic, wood, metal, glass, and/or rubber, for example. Tiles 206 may be formed using materials and manufacturing techniques found in other devices designed for easy positioning by hand or other movements by people, such as board game pieces, construction toys, computer peripherals, portable computing devices, cell phones, video game controllers, cars, and so on.

FIG. 11 illustrates one of many possible examples of a bisensory (tactile and visual) tile 206 of a multisensory system 200 for tactile symbol vocalization. The illustrated tile bears a Braille symbol 210 and a corresponding visual symbol 208; the visual symbol in this embodiment is slightly raised to illustrate the point that visual symbols are allowed but not required to be perfectly flat. A tile identifier in the form of an embedded RFID transmitter is shown in the illustrated tile; other tiles 206 may use other tile identifiers. As noted, the visual symbol 208 may also serve as a tile identifier 212 in systems 200 that use computer vision to distinguish between tiles.

In one implementation, each tile 206 is approximately 1 inch high, 0.75 inches wide, and 0.25 inches thick, made from plastic, and adapted from an off-the-shelf word game for blind people. It will be understood that this is merely one of many possible implementations, so embodiments are not necessarily limited to these specific dimensions and materials.

Returning to FIG. 2, the illustrated tile vocalization subsystem includes a sensing area 214 which produces tile placement signals 216 in response to placement of one or more tiles 206 within the sensing area. The tile placement signals 216 are used by a tile distinguisher 218 to produce tile identifications 220. A translator 222 uses the tile identifications 220 to produce phrase identifications 224, that is, identifications of audible phrases 226, which a phrase vocalizer 228 uses to emit audible phrases 226 as sound through one or more speakers 130.

In some embodiments, the translator 222 is effectively part of the phrase vocalizer 228, in that the phrase vocalizer 228 receives tile identifications 220 and then sends signals to drive the speaker(s) 130. For example, the tile identifications 220 may be used in some cases as indexes into a lookup table of .WAV files or other digital sound representations.

In some embodiments, the tile distinguisher 218 is effectively part of the sensing area 214, in that the sensing area not only registers placement of some tile when a tile is placed but also determines which tile was placed. In this case, the tile placement signals 216 also serve as tile identifications 220. In other embodiments, one mechanism (e.g., a light beam strength meter or an induced capacitance meter) is used to determine when some tile has been placed, and a different mechanism (e.g., computer vision tool, RFID reader, visual code reader) is used to determine which tile was placed. In some embodiments, a mechanism reads the tile identifier 212 and produces a corresponding tile identification 220.

Some embodiments include a lattice 230 of cells 232 which are sized and positioned to receive tiles 206. The lattice may be positioned above a flat surface sensing area 214 which lies in the field of view of a camera 128 that feeds tile images to a computer vision tile distinguisher 218, for example. In this case, tiles may be releasably held in their placed positions by cell walls and the underlying surface. The lattice may also take the form of a raised grid which is integral with a sensing area surface the tiles rest on, in which case tiles may have corresponding mating indentations on their undersides to help releasably hold the tiles in their respective placed positions.

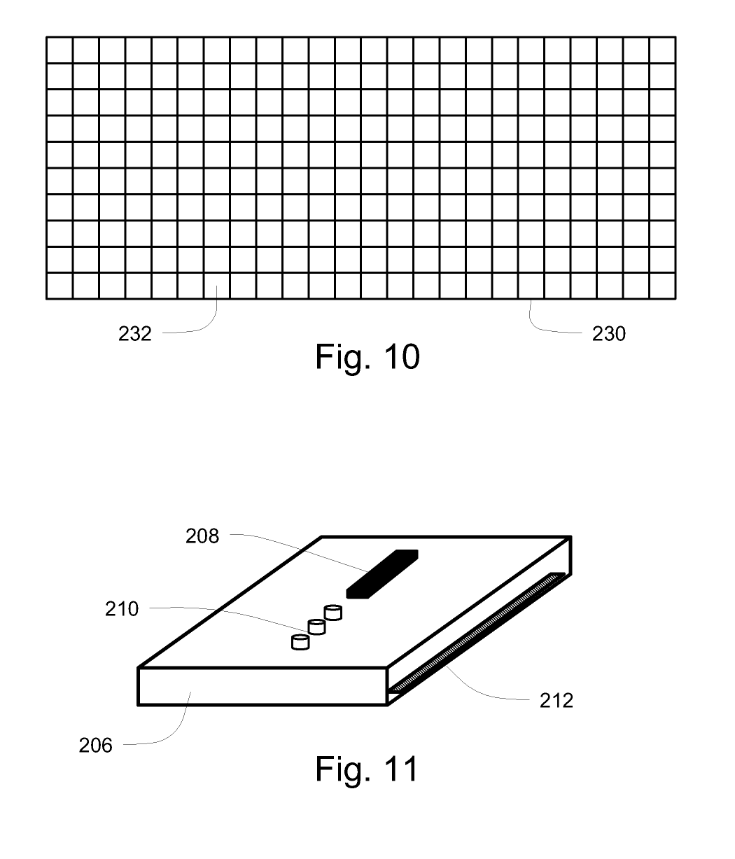

FIG. 10 illustrates a lattice 230 of cells 232 positioned over a sensing area of a multisensory system 200, in which the underlying surface is a tabletop or counter, and tiles are distinguished using computer vision. Lattice dimensions may vary. In one particular implementation, the lattice is 15 cells wide by 32 cells high, and made of laser-cut acrylic to hold tiles 206 that are approximately 1 inch high, 0.75 inches wide, and 0.25 inches thick. However, this is merely one of many possible implementations, so embodiments are not necessarily limited to these specific dimensions and materials.

In some embodiments, the lattice 230 is purely mechanical in nature, while in other embodiments it has both mechanical and electromagnetic/optic/electronic aspects. For example, a lattice cell (and/or the underlying surface) may include electromechanical, electromagnetic, optical, and/or electronic sensors to produce a tile placement signal 216 when a tile 206 is placed in the cell 232. In some embodiments, cells also include tile distinguishers 218 and produce signals indicating not only that a tile has been placed in the cell but which tile has been placed. In some embodiments, cells 232 have individual names 234 (e.g., “subject/object/verb”, or “A1, B2, X7”, or “numerator/denominator”). In some embodiments, a cell name vocalizer speaks aloud the cell's name when a tile is placed in the cell. Thus, a user will hear not only the name of the tile the user placed, but also the name of the cell or other position in which the tile was placed.

More generally, and with attention to FIG. 2, in some embodiments tiles 206, cells 232, lattices 230, and/or other pieces of a multisensory system 200 have associated metadata 238. Metadata may be vocalized by a vocalizer 228, 236, for example, and/or displayed on a display 126. Names, dates, authors, vendors, versions, help files, translations, transliterations, hints, and other information may be associated electronically with pieces of a multisensory system 200, e.g., as attributes, database values, file contents, or other data structures.

With reference to FIGS. 1 and 2, some embodiments provide a multisensory system 200 which includes a device or system 102 having a logical processor 110 and a memory medium 112 configured by circuitry, firmware, and/or software to transform physical tile placements into audible phrases as described herein. Some embodiments include a plurality of physically discrete tiles 206, each tile bearing a visual symbol 208 and a tactile symbol 210. A sensing area 214 is operable to receive a tile and produce a tile placement signal 216. A tile distinguisher 218 is operable to receive the tile placement signal and to produce a tile identification 220. A translator 222 is operable to receive the tile identification, to determine a phrase 226 based on the tile identification, and to produce a phrase identification 224 identifying the phrase. A phrase vocalizer 228 is operable to produce an audible phrase at a speaker 130 in response to the phrase identification.

In some embodiments, each tile 206 bears a single tactile symbol and a single visual symbol. In others, a tile bears a single tactile symbol and also bears two or more visual symbols which the tactile symbol may denote, depending on the tactile symbol's context.

In some embodiments, each tile 206 has a substantially rectangular three-dimensional shape. In other embodiments, tiles have different shapes, e.g., they may have handles, be shaped like game pieces, be shaped like country outlines in a map, and so on. In some embodiments, the tile is an object with surface(s) bearing tactile and visual information. Thus, a tile 206 is not necessarily a flat tile like a word game tile or domino. The tile could be a cube, or even an object with a more complex three-dimensional form, like a chess piece.

In some embodiments, the sensing area 214 includes a lattice 230 of cells 232. In some, the sensing area also has a cell name vocalizer 236 operable to produce an audible cell name 234 corresponding to a particular cell, in response to placement of a tile in the particular cell.

In some embodiments, the tile distinguisher 218 is operable to produce tile identifications 220 based on automatic analysis of tile visual symbols. For example, by analyzing a digital photographic image of a letter “C” printed on a tile, in one embodiment the tile distinguisher 218 produces a tile identification 220 distinguishing the tile from another tile that is imprinted with a different alphabet letter.

Some embodiments include a memory in operable communication with at least one processor 110. The memory medium 112 contains an application program 122 which is configured to respond to tile identifications 220. For example, tile placements could be used to control word games and other computerized games, to control education programs for learning and applying mathematical concepts, to control programs designed to manipulate images, to navigate through maps, and a wide variety of other kinds of application programs 122. The act of placing the tile serves as a command (e.g., as a “user gesture”), as part of an overall larger process of controlling a computer program. For example, a program might exit if a user places tiles forming the phrase “exit” in Braille. More generally, the computer program which is controlled (partially or fully) by tile placement may be an application, a command interpreter, or any other software, and may itself invoke or otherwise control additional software.

The multisensory system 200 may thus be viewed, in some embodiments, as a kind of computer peripheral. In some embodiments other peripherals 106 such as human user I/O devices (screen, keyboard, mouse, tablet, microphone, speaker, motion sensor, etc.) will also be present in operable communication with one or more processors 110 and memory.

In some embodiments, the system includes or communicates with multiple computers connected by a network. Networking interface equipment can provide access to networks 108, using components such as a packet-switched network interface card, a wireless transceiver, or a telephone network interface, for example, will be present in a computer system. However, an embodiment may also communicate through direct memory access, removable nonvolatile media, or other information storage-retrieval and/or transmission approaches, or an embodiment in a computer system may operate without communicating with other computer systems.

Processes

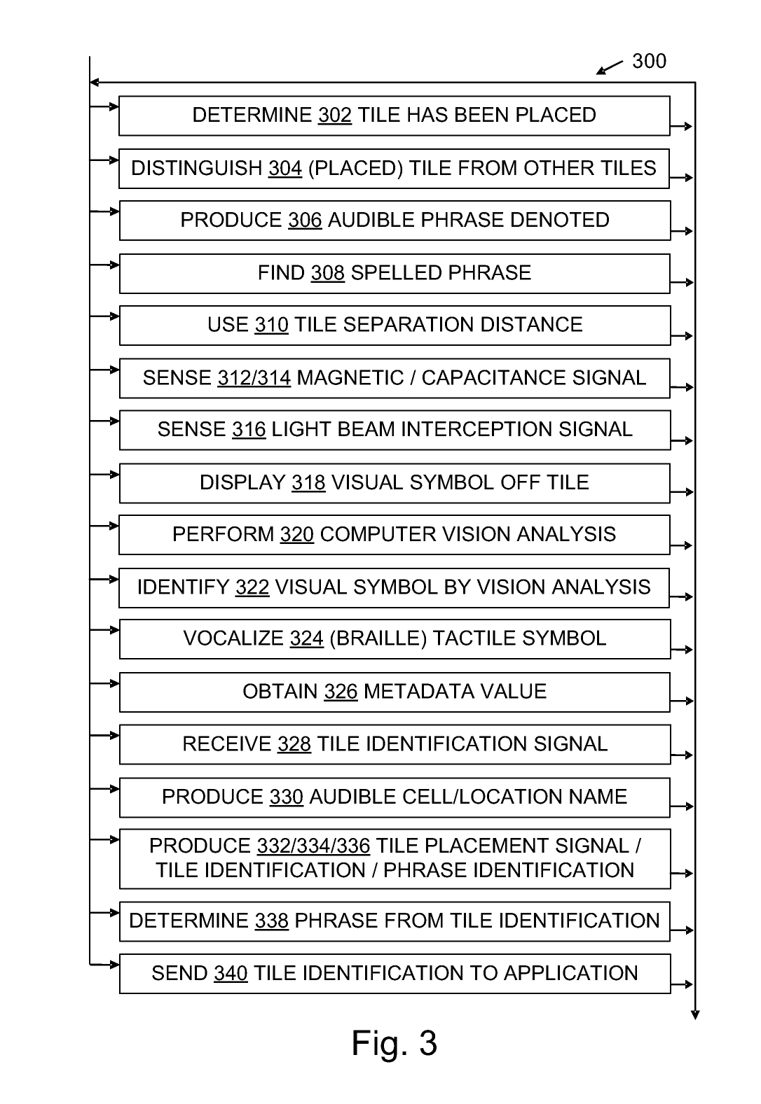

FIG. 3 illustrates some process embodiments in a flowchart 300. Processes shown in the Figures may be performed in some embodiments automatically, e.g., by programmed robot arm placing tiles in a multisensory system 200 under control of a script or the like requiring little or no human action. Processes may also be performed in part automatically and in part manually unless otherwise indicated. In a given embodiment zero or more illustrated steps of a process may be repeated, perhaps with different parameters or data to operate on. Steps in an embodiment may also be done in a different order than the top-to-bottom order that is laid out in FIG. 3. Steps may be performed serially, in a partially overlapping manner, or fully in parallel. The order in which flowchart 300 is traversed to indicate the steps performed during a process may vary from one performance of the process to another performance of the process. The flowchart traversal order may also vary from one process embodiment to another process embodiment. Steps may also be omitted, combined, renamed, regrouped, or otherwise depart from the illustrated flow, provided that the process performed is operable and conforms to at least one claim.

Examples are provided herein to help illustrate aspects of the technology, but the examples given within this document do not describe all possible embodiments. Embodiments are not limited to the specific implementations, arrangements, displays, features, approaches, or scenarios provided herein. A given embodiment may include additional or different features, mechanisms, and/or data structures, for instance, and may otherwise depart from the examples provided herein.

During a tile-placed determining step 302, an embodiment determines that a tile 206 has been placed in a sensing area 214. Step 302 does not necessarily determine which tile has been placed, or precisely where in the sensing area the tile has been placed. Step 302 may be accomplished using computer vision, interception of a light beam, RFID, visual code readers, weight sensors, motion sensors, induced capacitance, magnetic switches, and/or other mechanisms, for example.

During a tile distinguishing step 304, an embodiment distinguishes a tile that is being, or has been, placed in the sensing area, from at least one other tile 206. Step 304 does not necessarily determine where in the sensing area the tile has been placed, or how many copies of a tile have been placed. Step 304 may be accomplished using computer vision, RFID, visual code readers, and/or other mechanisms, for example.

During a phrase producing step 306, an embodiment produces an audible phrase 226 corresponding to a placed tile, or to an arrangement of placed tiles. The phrase may be emitted as recorded speech and/or as synthesized speech. For individual tiles, step 306 may be accomplished by looking up the tile's identification (which distinguishes 304 the tile from other tiles) in a table, tree, or other data structure and emitting a corresponding sound as the tile's name.

For tile arrangements, step 306 may include finding 308 a multi-tile sequence (or other spatial arrangement, e.g., for tiles representing an integral or a musical phrase) that is “spelled” by the tile arrangement. Some embodiments also look for similar arrangements, to respond gracefully to slight miss-spellings by finding 308 a word or other tile arrangement that was apparently intended by the user who placed the tiles. Spelling mechanisms used in word processors, web browsers, and other interfaces that accept spelled words may be adapted for use with tile sequences. As used herein, “spelling” may include checking linear sequences (as in words) and may also, depending on the embodiment, include checking two-dimensional tile arrangements, e.g., to spell a representation of a chemical compound, a representation of countries located relative to one another, a representation of an organization or other hierarchy, and so on. Likewise, as used herein, a “phrase” 226 may be a single character's name, e.g., “C”, or a word spelled with several tiles, e.g., “cake”, or a sequence of words, e.g., “capitol city” or “x equals six minus three”.

During a separation distance using step 310, an embodiment uses a measurement of physical distance between placed tiles 206 as a criterion. For example, tiles placed more than a predetermined distance apart may be treated as individual tiles, whereas tiles placed within that predetermined distance of one another may be treated as parts of a spelled phrase. Placing tiles for C, A, K, and E spaced apart would lead the system 200 to vocalize them as individual letters “see aye kay ee” but placing them near or touching each other would lead the system 200 to vocalize them as “cake”, or possibly as “see aye kay ee cake”. The separation distance may be specified in some embodiments as an absolute distance, e.g., one half inch or one centimeter, and may be specified in some in relative terms, e.g., one-quarter of a tile's width. In systems 200 having a lattice, the separation distance may be specified in cells, e.g., in an adjoining cell, or in an adjoining cell of the same row of cells. The separation distance may be measured using computer vision or other mechanisms. Step 310, like step 308, may be part of step 306.

During a magnetic signal sensing step 312, an embodiment senses a magnetic signal caused by tile movement. Step 312 may be accomplished using electromagnetic switches, RFID technology, or other mechanisms, for example.

During a capacitance signal sensing step 314, an embodiment senses a capacitance signal caused by tile movement. Step 314 may be accomplished using capacitance sensors or other mechanisms, for example.

During a light beam interception signal sensing step 316, an embodiment senses a signal caused by tile movement through a light beam. Step 316 may be accomplished using infrared or visible light photoelectric sensors, or other mechanisms, for example.

During a visual symbol displaying step 318, a copy (or near-copy, e.g., different font or different point size) of a tile's visual symbol is displayed off the tile, for possible viewing by sighted persons. In one embodiment, for example, the alphabet letters printed on tiles are projected onto a table surface in a sensing area in which the tiles are placed for computer vision analysis. In another embodiment, the visual symbol is displayed on a computer screen, cell phone, display, or other device screen.

During a vision analysis performing step 320, an embodiment performs computer vision analysis in response to a tile placement. The vision analysis may simply determine that a tile has been placed in a sensing area, namely, a field of vision, without identifying the particular tile placed. In some cases, however, the vision analysis also distinguishes 304 the placed tile. Step 320 may be accomplished using a camera 128, and processors 110 and memory 112 configured with vision analysis code to analyze an image captured with the camera. Familiar vision analysis tools and techniques may be used. In particular, optical character recognition may be part of step 320.

During an identifying step 322, an embodiment identifies a visual symbol of a placed tile by performing 320 computer vision analysis.

During a vocalizing step 324, an embodiment vocalizes a tactile symbol as a phrase 226, e.g., by playing through a speaker some recorded or synthesized sound(s) pronouncing the phrase.

During a metadata obtaining step 326, an embodiment obtains metadata associated with a piece of the system 200, such as tile metadata. Step 326 may be accomplished by using the tile (or other item's) identification as an index or handle to electronically locate the metadata in a medium 112.

During an identification signal receiving step 328, an embodiment (or portion thereof) receives a tile identification 220 signal, e.g., as values in a specified variable in memory 112.

During a location name producing step 330, an embodiment vocalizes a cell name 234 or other location name (e.g., “top left corner”, “between Canada and Mexico”) pertaining to placed tiles and/or to the sensing area, e.g., by playing through a speaker recorded or synthesized sounds pronouncing the name.

During a tile placement signal producing step 332, an embodiment (or portion thereof) produces a tile placement signal 216. Mechanisms for accomplishing step 332 include, for example, mechanisms corresponding to the mechanisms for determining 302 a tile has been placed, such as a computer vision camera, a light beam photosensor, an RFID sensor, visual code readers, weight sensors, motion sensors, induced capacitance sensors, and magnetic switches.

During a tile identification producing step 334, an embodiment (or portion thereof) produces a tile identification 220. Mechanisms for accomplishing step 334 include, for example, mechanisms corresponding to the mechanisms for distinguishing 304 a placed tile, such as a computer vision system, an RFID sensor and lookup, and visual code readers.

During a phrase identification producing step 336, an embodiment (or portion thereof) produces a phrase identification 224. Mechanisms for accomplishing step 336 include, for example, mechanisms noted in connection with phrase identification in discussing step 306.

During a phrase determining step 338, an embodiment (or portion thereof) determines a phrase from a tile identification. Mechanisms for accomplishing step 338 include, for example, mechanisms noted in discussing step 306.

During a tile identification sending step 340, an embodiment (or portion thereof) sends an application program 122 a tile identification. In this step, metadata 238 may also be sent, or may serve as the tile identification. Step 340 may be accomplished using familiar mechanisms for providing input to application programs 122, e.g., messaging, method invocations, shared memory, and so on, including in particular mechanisms used by keyboards, mice, or other familiar peripherals 106 to send input to application programs.

The foregoing steps and their interrelationships are discussed in greater detail below, in connection with various embodiments.

Some embodiments provide a process for audibly assisting a user of tactile symbols. The process electronically determines 302 that a tile has been placed in a sensing area. The tile bears a tactile symbol and also bears a corresponding visual symbol, and is one tile of a group 202 of tiles which collectively bear a plurality of tactile symbols and a plurality of corresponding visual symbols. The process automatically distinguishes 304 the placed tile from other tiles of the group, and electronically produces 306 an audible phrase denoted by the tactile symbol of the placed tile. As noted, an audible phrase may be derived from a logical combination of the tiles in the sensing area, such as a spelled or spoken word, an ordered sequence, or an equation.

Some processes also electronically determine 302 that a second tile of the group has been placed in the sensing area while the first tile is still in the sensing area, and automatically distinguish 304 the placed second tile from other tiles of the group. These processes electronically produce 306 an audible phrase denoted by the tactile symbol of the placed second tile, and/or an audible phrase spelled by the tactile symbols of placed tiles. The terms “phrase” and “spelled” are used broadly herein, rather than being confined to lay usage. For example, any of the following are phrases that could be spelled: a word, an equation, a point total calculated by adding up the points of each letter on an arrangement of placed tiled to obtain a word total.

In some embodiments, the process electronically produces 306 separate audible phrases corresponding to different placed titles when those placed tiles are physically separated by a predetermined separation distance, and electronically produces 306 an audible phrase that is spelled by the placed titles in combination when the placed tiles are physically separated by less than the predetermined separation distance.

In some embodiments, the step of electronically determining 302 that a tile has been placed in the sensing area includes sensing at least one of the following: an electromagnetic signal which depends at least in part on the tile's physical location; a signal generated by the tile physically intercepting a light beam; an induced capacitance signal which depends on the tile's physical location. In some embodiments, step 302 includes performing a computer vision analysis.

Some embodiments include generating electrically and then displaying 318 on a display 126 surface the visual symbol borne by the placed tile. For example, the visual symbol may be displayed on a computer display or it may be displayed as light projected on a tile-bearing surface. The displayed visual symbol need not correspond precisely with the symbol as shown on the tile, e.g., size, font, color, style or other characteristics may vary, provided the meaning is maintained.

In some embodiments, the step of automatically distinguishing 304 the placed tile from other tiles of the group includes performing 320 a computer vision analysis which identifies the visual symbol on the tile. In other embodiments, different mechanisms are used.

In some embodiments, the tactile symbol 210 of a placed tile includes a Braille symbol, and the step of electronically producing 306 an audible phrase produces an audible phrase denoted by the Braille symbol. It will be understood that a normal convention applies, in that a claim's apparently singular usage of “Braille symbol” (for example) is understood to mean “Braille symbol or symbols” unless clearly indicated otherwise.

In some embodiments, the process includes electronically obtaining 326 a metadata value that is assigned to at least one of the following: the placed tile, a lattice cell containing the placed tile. For example, a tile 206 could have multiple associated pieces of information tied. The tile could have a letter and a related number of points, for instance. A tile may thus have both human-sensible information physically located on the tile (tactile or visual), and metadata that can be assigned via an electronic application program 122. Similarly, a lattice cell or other sensing area location may have a specific label based on its location, e.g., B2, and may also have metadata, such as “Your hand”, “Playing area”, “Out of play”, or “Opponent's area”.

Some embodiments provide a process for assisting a user of tactile symbols. The process includes receiving 328 a signal in response to automated identification of a visual symbol borne by a tile, automatically distinguishing 304 the tile from other tiles of a group of tiles, based at least in part of the received signal, and electronically producing 306 an audible phrase that is denoted by a tactile symbol which is borne by the distinguished tile.

In some embodiments, the distinguished tile 206 is positioned at a particular location within a predetermined set of discrete locations, and the process electronically produces 330 an audible name of the particular location of the distinguished tile. For example, the distinguished tile may be positioned at a particular cell within a lattice 230 of cells 232, and the process electronically produces 330 an audible name 234 of that particular cell.

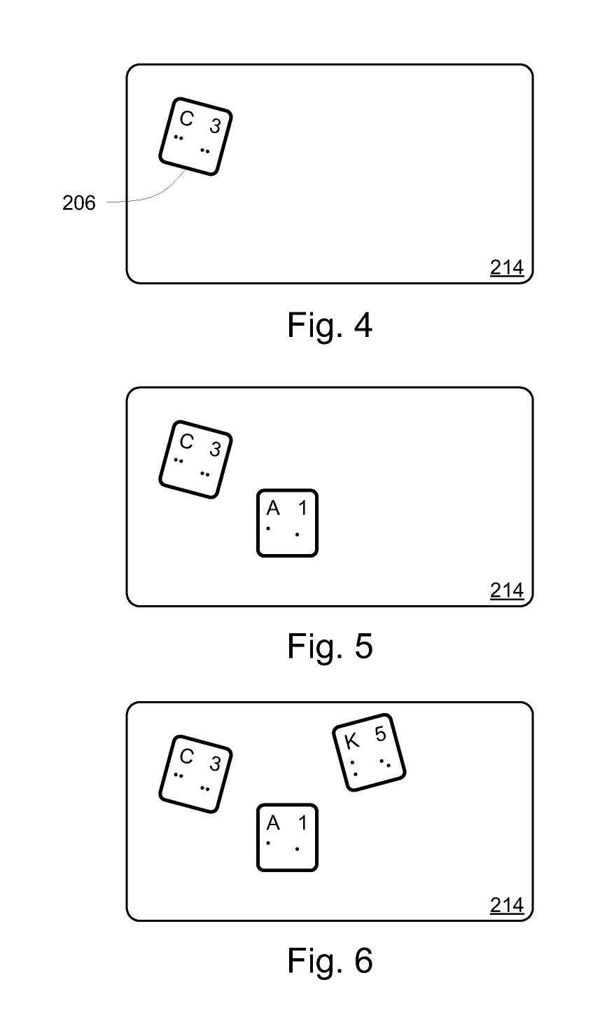

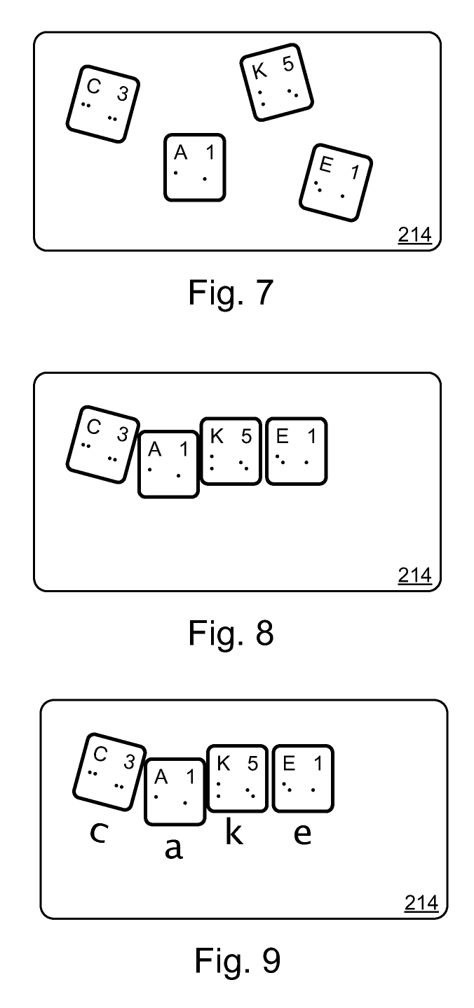

FIGS. 4 through 8 illustrate a sequence of placements of bisensory tactile tiles in a sensing area 214 of a multisensory system 200 for tactile symbol vocalization. A tile 206 bearing “C 3” and corresponding Braille is placed and the system speaks “C”; letters may have a higher priority than numbers, or number recognition may be disabled by a user, in some embodiments. Next, a tile bearing “A 1” is placed and the system speaks “A”. Then a tile bearing “K 5” is placed and the system speaks “K”. A tile bearing “E 1” is placed and the system speaks “E”. In FIG. 8, the tiles have been moved together, or at least within a separation distance of their neighbors, and so the system speaks “CAKE”. FIG. 9 corresponds generally with FIG. 8 but illustrates an alternative multisensory system configuration in which visual symbols corresponding to placed tactile tiles are also generated and displayed 318, e.g., by having their visual letters projected onto the sensing area surface.

Configured Media

Some embodiments include a configured computer-readable storage medium 112. Medium 112 may include disks (magnetic, optical, or otherwise), RAM, EEPROMS or other ROMs, and/or other configurable memory, including in particular non-transitory computer-readable media (as opposed to wires and other propagated signal media). The storage medium which is configured may be in particular a removable storage medium 114 such as a CD, DVD, or flash memory. A general-purpose memory, which may be removable or not, and may be volatile or not, can be configured into an embodiment using items such as tile identifications 220, phrase identifications 224, and a tile distinguisher 218, in the form of data 118 and instructions 116, read from a removable medium 114 and/or another source such as a network connection, to form a configured medium. The configured medium 112 is capable of causing a computer system to perform process steps for transforming tile movements into audible phrases as disclosed herein. FIGS. 1 through 3 thus help illustrate configured storage media embodiments and process embodiments, as well as system and process embodiments. In particular, any of the process steps illustrated in FIG. 3, or otherwise taught herein, may be used to help configure a storage medium to form a configured medium embodiment.

### CONCLUSION

Although particular embodiments are expressly illustrated and described herein as processes, as configured media, or as systems, it will be appreciated that discussion of one type of embodiment also generally extends to other embodiment types. For instance, the descriptions of processes in connection with FIG. 3 also help describe configured media, and help describe the operation of systems and manufactures like those discussed in connection with other Figures. It does not follow that limitations from one embodiment are necessarily read into another. In particular, processes are not necessarily limited to the data structures and arrangements presented while discussing systems or manufactures such as configured memories.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific features of an example may be omitted, renamed, grouped differently, repeated, instantiated in hardware and/or software differently, or be a mix of features appearing in two or more of the examples. Functionality shown at one location may also be provided at a different location in some embodiments.

Reference has been made to the figures throughout by reference numerals. Any apparent inconsistencies in the phrasing associated with a given reference numeral, in the figures or in the text, should be understood as simply broadening the scope of what is referenced by that numeral.

As used herein, terms such as “a” and “the” are inclusive of one or more of the indicated item or step. In particular, in the claims a reference to an item generally means at least one such item is present and a reference to a step means at least one instance of the step is performed.

Headings are for convenience only; information on a given topic may be found outside the section whose heading indicates that topic.

All claims as filed are part of the specification.

While exemplary embodiments have been shown in the drawings and described above, it will be apparent to those of ordinary skill in the art that numerous modifications can be made without departing from the principles and concepts set forth in the claims. Although the subject matter is described in language specific to structural features and/or procedural acts, it is to be understood that the subject matter defined in the appended claims is not necessarily limited to the specific features or acts described above the claims. It is not necessary for every means or aspect identified in a given definition or example to be present or to be utilized in every embodiment. Rather, the specific features and acts described are disclosed as examples for consideration when implementing the claims.

All changes which come within the meaning and range of equivalency of the claims are to be embraced within their scope to the full extent permitted by law.

What is claimed is:

1. A process for audibly assisting a user of tactile symbols, the process utilizing a device which has a predetermined sensing area, and at least one logical processor in operable communication with at least one memory, the process comprising the steps of:
electronically determining that a tile has been placed in the sensing area, the tile bearing a tactile symbol and also bearing a corresponding visual symbol, the tile being one tile of a group of tiles which collectively bear a plurality of tactile symbols and a plurality of corresponding visual symbols;
automatically distinguishing the placed tile from other tiles of the group; and
electronically producing an audible phrase denoted by the tactile symbol of the placed tile.

2. The process of claim 1, further comprising the steps of:
electronically determining that a second tile of the group has been placed in the sensing area while the first tile is still in the sensing area;
automatically distinguishing the placed second tile from other tiles of the group; and
electronically producing at least one of the following: an audible phrase denoted by the tactile symbol of the placed second tile, an audible phrase spelled by the tactile symbols of placed tiles.

3. The process of claim 1, comprising electronically producing separate audible phrases corresponding to different placed titles when those placed tiles are physically separated by a predetermined separation distance, and electronically producing an audible phrase that is spelled by the placed titles in combination when the placed tiles are physically separated by less than the predetermined separation distance.

4. The process of claim 1, wherein the step of electronically determining that a tile has been placed in the sensing area comprises sensing at least one of the following:
an electromagnetic signal which depends at least in part on the tile's physical location;
a signal generated by the tile physically intercepting a light beam;
an induced capacitance signal which depends on the tile's physical location.

5. The process of claim 1, further comprising generating electrically and then displaying on a display surface the visual symbol borne by the placed tile.

6. The process of claim 1, wherein the step of electronically determining that a tile has been placed in the sensing area comprises performing a computer vision analysis.

7. The process of claim 1, wherein the step of automatically distinguishing the placed tile from other tiles of the group comprises performing a computer vision analysis which identifies the visual symbol on the tile.

8. The process of claim 1, wherein the tactile symbol of the placed tile includes a Braille symbol, and the step of electronically producing an audible phrase produces an audible phrase denoted by the Braille symbol.

9. The process of claim 1, further comprising the step of electronically obtaining a metadata value that is assigned to at least one of the following: the placed tile, a lattice cell containing the placed tile.

10. A computer-readable non-transitory storage medium configured with data and with instructions that when executed by at least one processor causes the processor(s) to perform a process for assisting a user of tactile symbols, the process comprising the steps of:
receiving a signal in response to automated identification of a visual symbol borne by a tile,
automatically distinguishing the tile from other tiles of a group of tiles, based at least in part of the received signal; and
electronically producing an audible phrase that is denoted by a tactile symbol which is borne by the distinguished tile.

11. The configured medium of claim 10, wherein the distinguished tile is positioned at a particular location within a predetermined set of discrete locations, and the process further comprises electronically producing an audible name of the particular location of the distinguished tile.

12. The configured medium of claim 10, wherein the distinguished tile is positioned at a particular cell within a lattice of cells, and the process further comprises electronically producing an audible name of that particular cell.

13. The configured medium of claim 10, wherein the process further comprises:
automatically distinguishing a second tile from other tiles of the group; and
electronically producing an audible phrase denoted by the tactile symbol of the second tile.

14. The configured medium of claim 10, wherein the process further comprises:
automatically distinguishing at least one additional tile from other tiles of the group; and
electronically producing an audible phrase that is spelled by the tactile symbols of the distinguished tiles.

15. A multisensory system comprising:
a plurality of physically discrete tiles, each tile bearing a tactile symbol;
a sensing area operable to receive a tile and produce a tile placement signal;
a tile distinguisher operable to receive the tile placement signal and to produce a tile identification;
a translator operable to receive the tile identification, to determine a phrase based on the tile identification, and to produce a phrase identification; and
a phrase vocalizer operable to produce an audible phrase at a speaker in response to the phrase identification.

16. The system of claim 15, wherein each tile bears a single tactile symbol and a single visual symbol.

17. The system of claim 15, wherein each of a plurality of tiles has a substantially rectangular three-dimensional shape.

18. The system of claim 15, wherein the sensing area comprises a lattice of cells and a cell name vocalizer operable to produce an audible cell name corresponding to a particular cell in response to placement of the tile in the particular cell.

19. The system of claim 15, wherein the tile distinguisher is operable to produce tile identifications based on automatic analysis of tile visual symbols.

20. The system of claim 15, further comprising a memory in operable communication with at least one processor, the memory containing an application program which is configured to respond to tile identifications.
